(19) United States
(12) Patent Application Publication
(10) Pub. No.: US 2025/0307546 A1
(43) Pub. Date: Oct. 2, 2025

(54) SYSTEMS AND METHODS FOR LARGE LANGUAGE MODEL OPTIMIZATION USING PROMPT STRUCTURING

(71) Applicant: CyberArk Software Ltd., Petach-Tikva (IL)

(72) Inventor: Niv Rabin, Petach-Tikva (IL)

(73) Assignee: CyberArk Software Ltd., Petach-Tikva (IL)

(21) Appl. No.: 18/622,984

(22) Filed: Mar. 31, 2024

(51) Int. Cl. G06F 40/242; G06F 40/284

(52) U.S. Cl. CPC G06F 40/242; G06F 40/284

(57) ABSTRACT

Disclosed embodiments relate to updating an input for a large language model. Techniques include receiving the input from a user, applying a token classification model to the input to generate a replacement dictionary, applying a classification algorithm to the input to classify at least one of a nature or a structure of the input, updating, by a trained machine learning model, the input based on the replacement dictionary and the classified nature or structure of the input and transmitting the updated input to the at least one large language model.

### FIELD OF DISCLOSURE

The disclosed embodiments generally relate to systems, devices, methods, and computer-readable media for updating an input for at least one large language model.

### BACKGROUND

Monitoring user sessions within a system can provide meaningful insights on how users are interacting with the system and may identify suspicious behavior occurring within a user session. However, because user sessions may include large amounts of data and interactions, it can be difficult to generate meaningful insights or identify suspicious behavior through a manual review of the user sessions. To address this problem, large language models may be used to review and summarize user sessions. However, large language models have a maximum input size which restricts the amount of information that can be input as a prompt to a large language model. Additionally, inputting large amounts of information into a large language model increases the computational costs associated with the large language model by requiring a significant amount of memory and time to generate answer data. A common approach to the input size limit of large language models is to ask the large language model to summarize portions of the data. However, summarizations provided by the large language model may omit crucial parts of the data.

Therefore, to address these technical deficiencies in analyzing large amounts or a continuous stream of data through large language models, solutions should be implemented to update a user input for use in at least one large language model. Such solutions should reduce the input size of a user input without loss of the contextually important information in the input. Additionally, the input should be updated for one or more specific large language models that may be identified as suitable for analyzing the input. Such solutions should apply a token classification model to the input to generate a replacement dictionary and apply a classification algorithm to the input. The input received from the user should be updated based on the replacement dictionary and classified nature or structure of the input such that the input can be transmitted to at least one large language model within the maximum input size of the at least one large language model. Such solutions should minimize the computational costs associated with the memory and time needed for the large language model to generate answer data. These and other technological improvements and advantages are discussed below.

### SUMMARY

The disclosed embodiments describe non-transitory computer readable media for updating an input for at least one large language model. For example, in an embodiment, a non-transitory computer readable medium may include instructions that, when executed by at least one processor, cause the at least one processor to perform operations for updating an input for at least one large language model. The operations may comprise receiving the input from a user, applying a token classification model to the input to generate a replacement dictionary, applying a classification model to the input to classify at least one of a nature or a structure of the input, updating the input based on the replacement dictionary, identifying, based on the classified nature or the structure of the input, at least one large language model, converting the input in view of the at least one large language model by a trained machine learning model, and transmitting the converted input and the replacement dictionary to the at least one large language model.

According to a disclosed embodiment, the operations may further comprise identifying, based on the classified nature or the structure of the input, a large language model from the at least one large language model and transmitting the updated input to the at least one identified large language model.

According to a disclosed embodiment, the operations may further comprise converting the input into a text format.

According to a disclosed embodiment, the replacement dictionary may comprise one or more classified entities associated with the input.

According to a disclosed embodiment, the operations may further comprise identifying from a plurality of trained machine learning models the trained machine learning model for updating the input based on the classified nature or the structure of the input.

According to a disclosed embodiment, converting the input for the at least one large language model may comprise updating the input in view of at least one of a summarization related task, a code analysis related task, a log analysis related task, an audit analysis related task, or a configuration related task.

According to a disclosed embodiment, the input may comprise at least one of a prompt, a recorded session, an audit log, a policy, a code snippet, or a computer file. According to a disclosed embodiment, the trained machine learning model may comprise a sequence-to-sequence model with an encoder-decoder neural network architecture using long short-term memory layers.

According to a disclosed embodiment, the classification algorithm may identify a structure or a nature of the input and a corresponding large language model.

According to a disclosed embodiment, the nature of the input may comprise a task type of the input.

The disclosed embodiments further describe a computer-implemented method for updating an input for at least one large language model. For example, in an embodiment, a computer-implemented method for updating an input for at least one large language model may include operations that may comprise receiving the input from a user, applying a token classification model to the input to generate a replacement dictionary, applying a classification model to the input to classify at least one of a nature or a structure of the input, updating the input based on the replacement dictionary, identifying, based on the classified nature or the structure of the input, at least one large language model, converting the input in view of the at least one large language model by a trained machine learning model, and transmitting the converted input and the replacement dictionary to the at least one large language model.

According to a disclosed embodiment, updating the input by a trained machine learning model may comprise transmitting the input to a tokenization model, transmitting a tokenized input to a trained embedding model, receiving an embedded input sequence from the trained embedding model, transmitting the embedded input sequence to an encoder, receiving a context vector from the encoder, transmitting the context vector to a decoder, receiving a decoder output from the decoder, and evaluating the updated input.

According to a disclosed embodiment, evaluating the updated input may comprise transmitting a target sequence to a tokenization model, transmitting a tokenized target sequence to a trained embedding model, receiving an embedded target sequence from the trained embedding model, determining a similarity between the decoder output and the embedded target sequence, generating a loss based on the similarity, generating a length loss between the decoder output and the embedded target sequence, generating a total loss score based on the loss and the length loss, and computing a gradient of the total loss score with respect to parameters of the trained machine learning model.

According to a disclosed embodiment, the computer-implemented method may further comprise backpropagating the total loss score to adjust the machine learning model parameters.

According to a disclosed embodiment, updating the input by a trained machine learning model may comprise transmitting the input to a tokenization model, transmitting the tokenized input to a trained embedding model, receiving an embedded input sequence from the trained embedding model, transmitting the embedded input sequence to an encoder, receiving a context vector from the encoder, iterating the context vector from the encoder to receive a probability distribution from a decoder, and sampling a word from the probability distribution to generate the updated input

According to a disclosed embodiment, the computer-implemented method may further comprise converting the updated input into a format readable by the at least one large language model.

According to a disclosed embodiment, the computer-implemented method may further comprise identifying from a plurality of trained machine learning models the trained machine learning model for updating the input based on the classified nature or structure of the input.

According to a disclosed embodiment, the computer-implemented method may further comprise identifying, based on the identified trained machine learning model, a large language model from the at least one large language models, and transmitting the input to the identified large language model.

According to a disclosed embodiment, the computer-implemented method may further comprise transmitting a first portion of the input to a first large language model and transmitting a second portion of the input to a second large language model.

According to a disclosed embodiment, the computer-implemented method may further comprise replacing a value of the input with a variable from the replacement dictionary.

Aspects of the disclosed embodiments may include tangible computer readable media that store software instructions that, when executed by one or more processors, are configured for and capable of performing and executing one or more of the methods, operations, and the like consistent with the disclosed embodiments. Also, aspects of the disclosed embodiments may be performed by one or more processors that are configured as special-purpose processor(s) based on software instructions that are programmed with logic and instructions that perform, when executed, one or more operations consistent with the disclosed embodiments.

It is to be understood that both the foregoing general description and the following detailed description are exemplary and explanatory only and are not restrictive of the disclosed embodiments.

### BRIEF DESCRIPTION OF THE DRAWINGS

The accompanying drawings, which are incorporated in and constitute a part of this specification, illustrate disclosed embodiments and, together with the description, explain the disclosed embodiments.

FIG. 1 is a block diagram of a system for providing updates to an input for at least one large language model, in accordance with disclosed embodiments.

FIG. 2 is a block diagram of a computing device including a prompt structuring model for updating an input for at least one large language model, in accordance with disclosed embodiments.

FIG. 3 is a block diagram of a process for updating an input for at least one large language model, in accordance with disclosed embodiments.

FIG. 4 is a block diagram of a process for training a machine learning model, in accordance with disclosed embodiments.

FIG. 5 is a block diagram of a process for evaluating a prompt structuring model, in accordance with disclosed embodiments.

FIG. 6 is a block diagram of a process of generating an inference using a prompt structuring model, in accordance with disclosed embodiments.

FIG. 7 is a flowchart of a process for updating an input for at least one large language model, in accordance with disclosed embodiments.

### DETAILED DESCRIPTION

In the following detailed description, numerous specific details are set forth to provide a thorough understanding of the disclosed example embodiments. However, it will be understood by those skilled in the art that the principles of the example embodiments may be practiced without every specific detail. Well-known methods, procedures, and components have not been described in detail so as not to obscure the principles of the example embodiments. Unless explicitly stated, the example methods and processes described herein are not constrained to a particular order or sequence or constrained to a particular system configuration. Additionally, some of the described embodiments or elements thereof can occur or be performed simultaneously, at the same point in time, or concurrently.

The techniques for updating an input for at least one large language model described herein overcome several technological problems relating to the efficiency and functionality of large language models. In particular, the disclosed embodiments provide techniques for updating an input for at least one large language model to meet input size requirements of the large language model without losing important details from the input data. As discussed above, large language models may have a limit on the size of the input which may limit the ability of the large language model to analyze large data sets, such as user sessions. Existing techniques of receiving summaries of large amounts of data from a large language model, however, fail to ensure that all crucial details in the data sets are included in the summaries.

The disclosed embodiments provide technical solutions to these and other problems arising from current techniques. For example, various disclosed techniques create efficiencies over current techniques by providing a prompt structuring model that can update user inputs through use of a token classification model and a classification algorithm. The disclosed techniques may reduce the size of the user input to meet the size restrictions of an identified large language model without losing crucial details from the input data. The disclosed techniques may also identify one or more large language models that may be suitable for analyzing the user input and providing answer data in response to the user input. The disclosed techniques may reduce computational costs and increase computational efficiencies associated with receiving answer data from a large language model by reducing the input size transmitted to the large language model.

Reference will now be made in detail to the disclosed embodiments, examples of which are illustrated in the accompanying drawings.

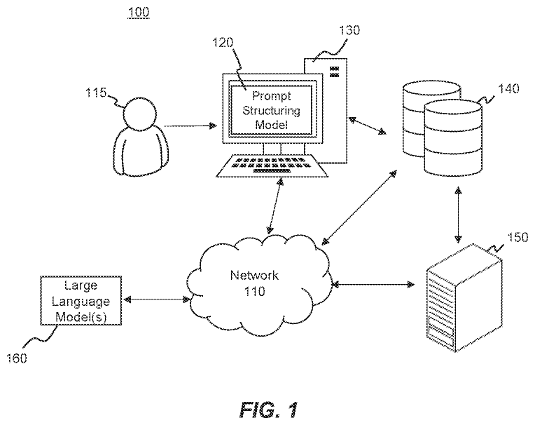

FIG. 1 illustrates an exemplary system 100 for updating an input for at least one large language model, consistent with the disclosed embodiments. System 100 may represent an environment in which software code is developed and/or executed, for example in a cloud computing environment. System 100 may include one or more prompt structuring model 120, one or more computing devices 130, one or more databases 140, one or more servers 150, and one or more large language models 160, as shown in FIG. 1. User 115 may engage with system 100 through computing device 130.

The various components may communicate over a network 110. Such communications may take place across various types of networks, such as the Internet, a wired Wide Area Network (WAN), a wired Local Area Network (LAN), a wireless WAN (e.g., WiMAX), a wireless LAN (e.g., IEEE 802.11, etc.), a mesh network, a mobile/cellular network, an enterprise or private data network, a storage area network, a virtual private network using a public network, a nearfield communications technique (e.g., Bluetooth, infrared, etc.), or various other types of network communications. In some embodiments, the communications may take place across two or more of these forms of networks and protocols. While system 100 is shown as a network-based environment, it is understood that the disclosed systems and methods may also be used in a localized system, with one or more of the components communicating directly with each other.

Computing devices 130 may be a variety of different types of computing devices capable of developing, storing, analyzing, and/or executing software code. For example, computing device 130 may be a personal computer (e.g., a desktop or laptop), an IoT device (e.g., sensor, smart home appliance, connected vehicle, etc.), a server, a mainframe, a vehicle-based or aircraft-based computer, a virtual machine (e.g., virtualized computer, container instance, etc.), or the like. Computing device 130 may be a handheld device (e.g., a mobile phone, a tablet, or a notebook), a wearable device (e.g., a smart watch, smart jewelry, an implantable device, a fitness tracker, smart clothing, a head-mounted display, etc.), an IoT device (e.g., smart home devices, industrial devices, etc.), or various other devices capable of processing and/or receiving data. Computing device 130 may operate using a Windows™ operating system, a terminal-based (e.g., Unix or Linux) operating system, a cloud-based operating system (e.g., through AWS™, Azure™, IBM Cloud™, etc.), or other types of non-terminal operating systems.

System 100 may further comprise one or more database(s) 140, for storing and/or executing software. For example, database 140 may be configured to store software or code, such as code developed using computing device 130. Database 140 may further be accessed by computing device 130, server 150, or other components of system 100 for downloading, receiving, processing, editing, or running the stored software or code. Database 140 may be any suitable combination of data storage devices, which may optionally include any type or combination of databases, load balancers, dummy servers, firewalls, back-up databases, and/or any other desired database components. In some embodiments, database 140 may be employed as a cloud service, such as a Software as a Service (SaaS) system, a Platform as a Service (PaaS), or Infrastructure as a Service (IaaS) system. For example, database 140 may be based on infrastructure or services of Amazon Web Services™ (AWS™), Microsoft Azure™ Google Cloud Platform™, Cisco Metapod™, Joyent™, vmWare™, or other cloud computing providers. Data sharing platform 140 may include other commercial file sharing services, such as Dropbox™, Google Docs™, or iCloud™. In some embodiments, data sharing platform 140 may be a remote storage location, such as a network drive or server in communication with network 110. In other embodiments database 140 may also be a local storage device, such as local memory of one or more computing devices (e.g., computing device 130) in a distributed computing environment.

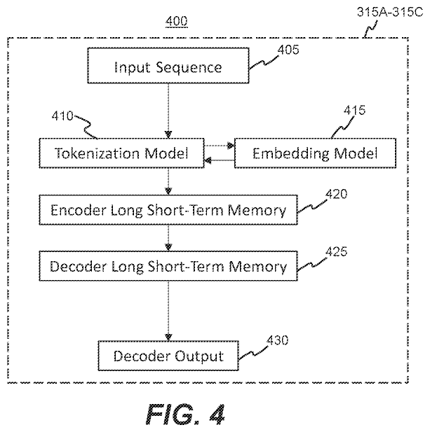

System 100 may also comprise one or more server device(s) 150 in communication with network 110. Server device 150 may manage the various components in system 100. In some embodiments, server device 150 may be configured to process and manage requests between computing devices 130 and/or databases 140. In embodiments where software code is developed within system 100, server device 150 may manage various stages of the development process, for example, by managing communications between computing devices 130 and databases 140 over network 110. Server device 150 may identify updates to code in database 140, may receive updates when new or revised code is entered in database 140, and may participate in updating an input for at least one large language model as discussed below in connection with FIGS. 4-7.

System 100 may also comprise one or more prompt structuring models 120 in communication with network 110. Prompt structuring model 120 may be any device, component, program, script, or the like, for updating an input for at least one large language model within system 100, as described in more detail below. Prompt structuring model 120 may be configured to monitor other components within system 100, including computing device 130, database 140, and server 150. In some embodiments, prompt structuring model 120 may be implemented as a separate component within system 100, capable of analyzing software and computer codes or scripts within network 110. In other embodiments, prompt structuring model 120 may be a program or script and may be executed by another component of system 100 (e.g., integrated into computing device 130, database 140, or server 150). Prompt structuring model 120 may further comprise one or more components for performing various operations of the disclosed embodiments. For example, prompt structuring model 120 may be configured to receive input from a user, apply a token classification model to the input to generate a replacement dictionary, apply a classification algorithm to the input to classify at least one of a nature or a structure of the input, update, by a trained machine learning model, the input based on the replacement dictionary, and the classified nature or structure of the input, and transmit the updated input to the at least one large language model as discussed below.

System 100 may further comprise at least one large language model 160. Large language model 160 may be any system, device, component, program, script, or the like, for receiving an updated input within system 100. For example, in some embodiments, large language model 160 may comprise a large language model such as GPT™, LLaMA™, Gemini™, Microsoft Copilot™, Google Bard™, Claude™, or any other type of model or operation associated with a natural language. Large language model 160 may be in any desired form, such as a statistical model (e.g., a word n-gram language model, an exponential language model, or a skip-gram language model) or a neural model (e.g., a recurrent neural network-based language model or a LLM). In some examples, large language model 160 may include a LLM with artificial neural networks, transformers, and/or other desired machine learning architectures. In some embodiments, large language model 160 may include a trained language model. Large language model 160 may be trained using, for example, supervised learning, self-supervised learning, semi-supervised learning, unsupervised learning, and/or reinforcement learning. In some examples, large language model 160 may be pre-trained to generally understand a natural language, and the pre-trained language model may be fine-tuned for software development. For example, the pre-trained language model may be fine-tuned for software generation tasks based on training data of descriptions associated with software generation tasks, and the fine-tuned language model may be used to receive and process the identified software generation task. In some examples, large language model 160 may include generative pre-trained transformers (GPT) or other types of generative artificial intelligence configured to generate human-like content.

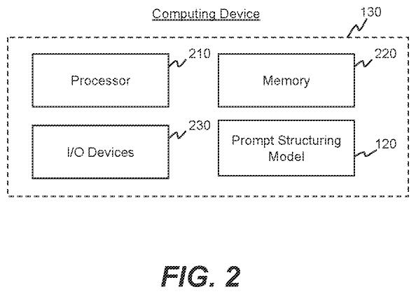

FIG. 2 is a block diagram showing a computing device 130 including prompt structuring model 120 in accordance with disclosed embodiments. Computing device 130 may include a processor (or processors) 210. Processor (or processors) 210 may include one or more data or software processing devices. For example, processor 210 may take the form of, but is not limited to, a microprocessor, embedded processor, or the like, or may be integrated in a system on a chip (SoC). Furthermore, according to some embodiments, processor 210 may be from the family of processors manufactured by Intel®, AMD®, Qualcomm®, Apple®, NVIDIA®, or the like. Processor 210 may also be based on the ARM architecture, a mobile processor, or a graphics processing unit, etc. In some embodiments, prompt structuring model 120 may be employed as a cloud service, such as a Software as a Service (SaaS) system, a Platform as a Service (PaaS), or Infrastructure as a Service (IaaS) system. For example, prompt structuring model 120 may be based on infrastructure of services of Amazon Web Services™ (AWS™), Microsoft Azure™, Google Cloud Platform™, Cisco Metapod™, Joyent™, vmWare™, or other cloud computing providers. The disclosed embodiments are not limited to any type of processor configured in the computing device 130.

Memory (or memories) 220 may include one or more storage devices configured to store instructions or data used by the processor 210 to perform functions related to the disclosed embodiments. Memory 220 may be configured to store software instructions, such as programs, that perform one or more operations when executed by the processor 210 to update an input for at least one large language model from computing device 130, for example, using process 700, described in detail below. The disclosed embodiments are not limited to software programs or devices configured to perform dedicated tasks. For example, the memory 220 may store a single program, such as a user-level application, that performs the functions of the disclosed embodiments, or may comprise multiple software programs. Additionally, the processor 210 may in some embodiments execute one or more programs (or portions thereof) remotely located from the computing device 130. Furthermore, the memory 220 may include one or more storage devices configured to store data (e.g., machine learning data, training data, algorithms, etc.) for use by the programs, as discussed further below.

Computing device 130 may further include one or more input/output (I/O) devices 230. I/O devices 230 may include one or more network adaptors or communication devices and/or interfaces (e.g., WiFi, Bluetooth®, RFID, NFC, RF, infrared, Ethernet, etc.) to communicate with other machines and devices, such as with other components of system 100 through network 110. For example, prompt structuring model 120 may use a network adaptor to scan for code and code segments within system 100. In some embodiments, the I/O devices 230 may also comprise a touchscreen configured to allow a user to interact with prompt structuring model 120 and/or an associated computing device. The I/O device 230 may comprise a keyboard, mouse, trackball, touch pad, stylus, and the like.

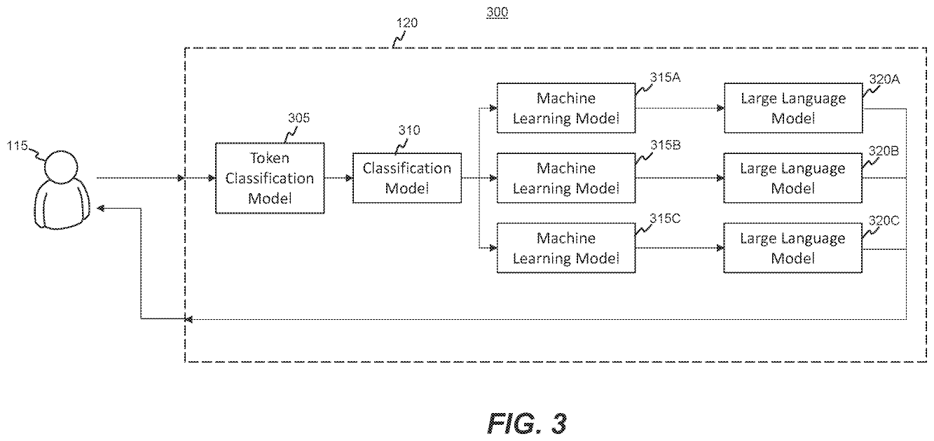

FIG. 3 is a block diagram of a process 300 for updating an input for at least one large language model, in accordance with disclosed embodiments. As depicted in FIG. 3, user 115 may provide an input to prompt structuring model 120 for updating and transmission to at least one large language model 320A, 320B, 320C (320A-320C). The input from user 115 may include, for example, a recorded session, an audit log, a policy, a code snippet, a computer file, a document, an image, a video, or any other form of input. Prompt structuring model 120 may apply a token classification model 305 to the input received from user 115 to generate a replacement dictionary. Token classification model 305 may comprise a natural language model configured to assign a label to specific tokens in an input. For example, token classification model 305 may utilize Named Entity Recognition (NER) to identify specific entities in an input, such as a date, an individual, a place, a task, an organization, or any other specific entity in an input. Token classification model 305 may label each identified entity to generate a replacement dictionary. The replacement dictionary may store each of the identified entities and a replacement label for each identified entity. The replacement label for each identified entity may be shorter in length than the identified entity name to reduce the input size of the overall updated input to the machine learning model.

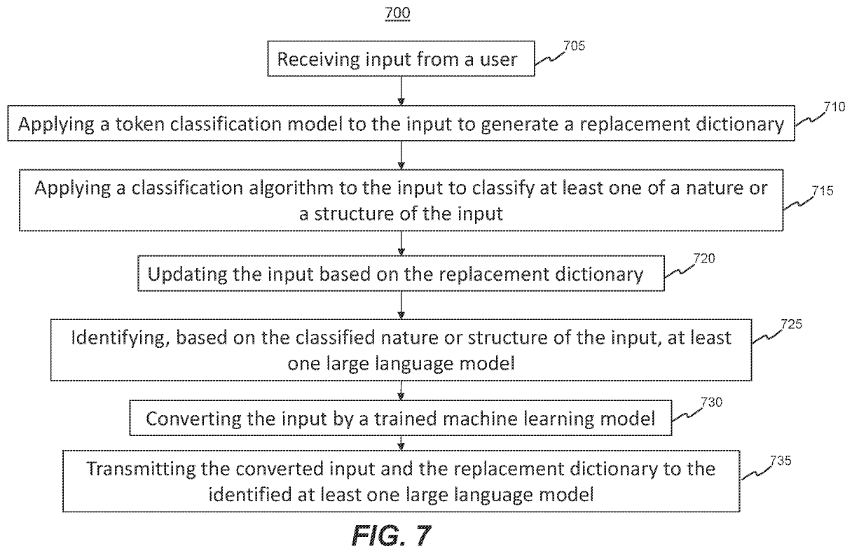

A classification algorithm 310 may then be applied to the input. The classification algorithm 310 may comprise a machine learning process of categorizing an input into classes based on one or more variables. The classification algorithm 310 may predict a likelihood or probability that the input fits into one or more predetermined categories. For example, classification algorithm 310 may classify at least one of a nature or a structure of the received input. The nature of the received input may include a task type of the input. For example, the input may comprise a task to summarize the input, explain the input, analyze the input, or any other task related to the input. The structure of the input may comprise a format of the input. For example, the input may comprise a recorded session, an audit log, a policy, a code snippet, a computer file, or any other format of input. The classification algorithm may identify and classify the nature or the structure of the input. Classifying the nature or the structure of the input may determine which trained machine learning model, 315A, 315B, 315C (315A-320C) the input should be transmitted to and which large language model 320A-320C the updated input should be transmitted to, as disclosed herein with respect to FIG. 7.

Process 300 may further include updating the input based on the replacement dictionary. The replacement dictionary generated by token classification model 305 may contain a plurality of labels that may be associated with specific entities in an input, such as a date, an individual, a place, a task, an organization, or any other specific entity in an input. Process 300 may replace the entities identified by token classification model 305 with the corresponding replacement labels contained in the replacement dictionary. The replacement label for each identified entity may be shorter in length than the identified entity name which may reduce the input size of the overall updated input to the machine learning model.

Process 300 may also include identifying, based on the classified nature or the structure of the input, at least one large language model 320A-320C. Each of the at least one large language models 320A-320C may be suitable for receiving and analyzing specific categories of inputs. For example, one large language model may be suited to receive and analyze a prompt, a recorded session, an audit log, a policy, a code snippet, or a computer file. Further, each large language model 320A-320C may be suited to complete a specific task type, such as to summarize, analyze, or configure the updated input. At least one large language model may be identified during process 300 based on the classified nature or structure of the input. The at least one identified large language model may be identified as the most suitable large language model to provide answer data in response to the updated input.

The classified input may then be transmitted to at least one of machine learning models 315A-315C. Machine learning models 315A-315C may convert the input prior to transmitting the input to the at least one large language model 320A-320C. Each machine learning model 315A-315C may comprise one or more of classifiers, neural networks, regression models, clustering models, transformer models, encoder-decoder models, or the like, as non-limiting examples. Machine learning model 315A-315C may comprise a model configured for generative artificial intelligence, including generative models such as transformers, generative adversarial networks, autoregressive models, diffusion models, and/or autoencoders. Machine learning models 315A-315C may be configured to convert the input in view of the at least one large language model. Converting the input may comprise compressing or reducing a size of the input without losing the contextual information of the input. Further, converting the input may comprise converting the format of the input into a format that may be best suited for the identified at least one large language model. For example, if the identified at least one large language model interprets prompts in the form of emojis, then converting the input may comprise converting the format of the input into emojis. In another example, if the identified at least one large language model interprets prompts in binary form, then converting the input may comprise converting the input into binary format. In another example, if the identified at least one large language model interprets prompts in a non-human readable language, then converting the input may comprise converting the input into the non-human readable language used by the identified at least one large language model. Machine learning models 315A-315C may convert the format of the input into any format that may be suitable for the identified at least one large language model.

Each of machine learning models 315A-315C may be suitable to update a different type of input comprising a certain task type or format, as classified by the classification algorithm 310. For example, machine learning models 315A-315C may each be configured to convert the input for the at least one large language model in view of a summarization related task, a code analysis related task, a log analysis related task, an audit analysis related task, or a configuration related task. A summarization related task may provide a shorter version of an input while preserving the contextually important information. A code analysis related task may provide analysis of code or minification of code. A log analysis related task may analyze a log file or a recorded session. An audit analysis related task may analyze an audit log or a recorded session audit. A configuration related task may merge or adjust policies or configurations. Each of machine learning models 315A-315C may be suited to convert the input to a specific format, based on the identified nature or structure of the input. For example, a machine learning model may be suited to convert the input to emojis, to binary, or to any other input format. The classification of the nature or structure of the input by classification algorithm 310 may determine which of machine learning models 315A-315C may convert the input.

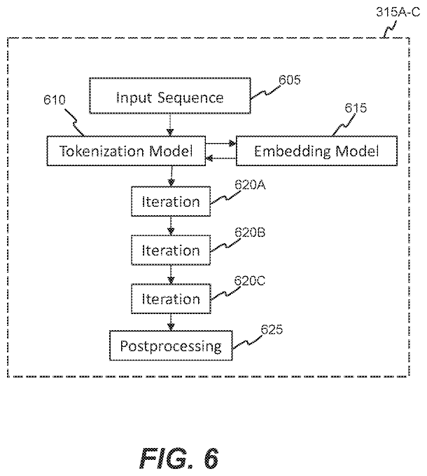

Machine learning models 315A-315C may convert the input in view of the at least one large language model, as disclosed herein with respect to FIG. 6, and then transmit the updated input to at least one of large language model 320A-320C. Large language models 320A-320C may correspond to large language model 160, as disclosed herein with respect to FIG. 1. The large language models 320A-320C may generate answer data based on the updated input and the answer data may be transmitted through prompt structuring model 120 to user 115. Although FIG. 3 depicts three machine learning models 315A-315C and three large language models 320A-320C, prompt structuring model 120 may include more or fewer machine learning models and large language models.

FIG. 4 is a block diagram of a process 400 for training a machine learning model, such as machine learning models 315A-315C. Training machine learning models 315A-315C may include one or more of adjusting parameters (e.g., parameters of the model), removing parameters, adding parameters, generating functions, generating connections (e.g., neural network connecting), or any other machine training operation. In some embodiments, training may involve performing iterative and/or recursive operations to improve model performance.

As depicted in FIG. 4, an input sequence 405 may be input into at least one of machine learning models 315A-315C. Input sequence 405 may comprise any input that may be transmitted to a machine learning model, converted from any convertible format, including but not limited to a prompt, a recorded session, an audit log, a policy, a code snippet, or a computer file. Input sequence 405 may include a training data set that may be used to train machine learning models 315A-315C. The input sequence 405 may first be transmitted to a tokenization model 410 in machine learning model 315A-315C. Tokenization model 410 may convert input 405 into smaller tokens. Tokenization of input 405 may convert input 405 into a format that may be more easily interpreted and analyzed by machine learning models 315A-315C. Tokenization model 410 may comprise sentence tokenization, word tokenization, character tokenization, whitespace tokenization, subword tokenization, or any other form of tokenization suitable for converting input 405 into tokens.

The tokenized input may be transmitted from tokenization model 410 to embedding model 415. Embedding model 415 may comprise a trained algorithm that may condense the tokenized input into dense representations in a multi-dimensional space. For example, embedding model 415 may convert the tokenized input into an embedded input sequence. Embedding model 415 may comprise embedding models such as Word2Vec, GloVe, ELMo, BERT, Doc2Vec, CNN Embeddings, Principal Component Analysis (PCA), Singular Value Decomposition (SVA), or any other embedding model suitable for converting the tokenized input into an embedded input sequence. The embedded input sequence may then be returned to tokenization model 410 and transmitted from tokenization model 410 to encoder long short-term memory 420.

Encoder long short-term memory 420 may process the embedded input sequence and capture contextual information to produce a context vector. Encoder long short-term memory 420 may comprise a recurrent neural network (RNN). Encoder long short-term memory 420 may encode and summarize the entire embedded input sequence into a context vector. The context vector may capture semantic and syntactic information associated with the embedded input sequence. The context vector may be transmitted from encoder long short-term memory 420 to decoder long short-term memory 425. Decoder long short-term memory 425 may produce a probability distribution over vocabulary to represent the likelihood of each word being the next word in the sequence. The decoder long short-term memory 425 may take the context vector from the encoder long-short term memory 420 as an initial state. Decoder long short-term memory 425 may generate an output sequence word-by-word and may use an embedding layer to represent the output words. Decoder long short-term memory 425 may generate an output sequence, such as decoder output 430. Decoder output 430 may comprise a generated sequence that may represent a compressed version of the input sequence 405.

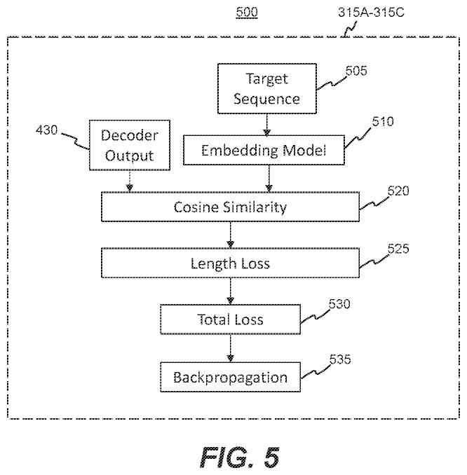

FIG. 5 is a block diagram of a process 500 for evaluating the output, such as decoder output 430, of a machine learning model, such as machine learning models 315A-315C against a target sequence 505. A target sequence 505 may be transmitted to an embedding model 510. Target sequence 505 may comprise a form of training data that may represent a desired output from machine learning model 315A-315C. For example, target sequence 505 may represent a compressed sequence of data corresponding to a longer user input. Embedding model 510 may correspond to embedding model 415, as disclosed herein with respect to FIG. 4. Embedding model 510 may convert the target sequence 505 into an embedded target sequence. The embedded target sequence generated by embedding model 510 may represent the semantic information of each word of target sequence 505.

The decoder output 430 generated by process 400 and the embedded target sequence associated with target sequence 505 may be used to generate a custom loss calculation. The cosine similarity 520 of decoder output 430 and the embedded target sequence may be calculated. The cosine similarity 520 may measure the cosine of the angle between two vectors, such as decoder output 430 and the embedded target sequence. Cosine similarity 520 may range, as an example, from −1 (completely dissimilar) to 1 (completely similar). After determining the cosine similarity 520 between the decoder output 430 and the embedded target sequence, a cosine loss may be calculated. The cosine loss may reflect how dissimilar the decoder output 430 is from the embedded target sequence. The cosine loss may ensure that the decoder output 430 is semantically similar to the embedded target sequence. It is desired that machine learning model 315A-315C maintain the details of a user input such that the updated input does not remove critical information from the user input. Calculating the cosine loss may train machine learning model 315A-315C to generate semantically accurate sequences.

The length loss 525 may then be calculated. The length loss 525 may comprise the absolute difference in length between the embedded target sequence and decoder output 430. The length loss 525 may penalize deviations in sequence length which may train machine learning model 315A-315C to generate sequences of an appropriate length. For example, it is desired that machine learning model 315A-315C compress input data without losing the detailed content of the input. Therefore, calculating the length loss 525 may train the machine learning model 315A-315C to generate shorter and more condensed output sequences.

The total loss 530 may be calculated to determine an overall loss score of the decoder output 430. The total loss 530 may use a hyperparameter to determine a balance between the cosine loss and the length loss 525. The total loss 530 may reflect the semantic and length inaccuracies of the decoder output 430 as compared to the target sequence 505. The total loss 530 may be used for backpropagation 535. Backpropagation 535 may comprise a gradient estimation method to compute parameter updates to machine learning model 315A-315C as part of training machine learning model 315A-315C. Backpropagation 535 may compute a gradient loss function of the weights of machine learning model 315A-315C. For example, backpropagation 535 may calculate how much each parameter in the machine learning model 315A-315C may contribute to total loss 530. The parameters of machine learning model 315A-315C may be adjusted to correct the errors identified through the total loss 530 and backpropagation 535.

FIG. 6 depicts a block diagram of a process of generating an inference using a machine learning model, such as machine learning models 315A-315C. An input sequence 605 may be input to machine learning model 315A-315C. Input sequence 605 may correspond to input sequence 405, as disclosed herein with respect to FIG. 4. For example, input sequence 605 may comprise text format that may be transmitted to a machine learning model, converted from any convertible format, including but not limited to a prompt, a recorded session, an audit log, a policy, a code snippet, or a computer file. Input sequence may be input to a tokenization model 610. Tokenization model 610 may correspond to tokenization model 410, as disclosed herein with respect to FIG. 4. For example, tokenization of input 605 may convert input 605 into a format that may be more easily interpreted and analyzed by machine learning models 315A-315C. Tokenization model 610 may comprise sentence tokenization, word tokenization, character tokenization, whitespace tokenization, subword tokenization, or any other form of tokenization suitable for converting input 605 into tokens. The tokenized input 605 may be transmitted to embedding model 615. Embedding model 615 may correspond to embedding model 415, as disclosed herein with respect to FIG. 4. For example, embedding model 615 may comprise a trained algorithm that may condense the tokenized input 605 into dense representations in a multi-dimensional space. For example, embedding model 615 may convert the tokenized input into an embedded input sequence.

Machine learning model 315A-315C may iterate over the embedded input sequence through iteration 620A, 620B, an 620C (620A-620C). Machine learning models 315A-315C may complete iterations 620A-620C through an encoder-decoder architecture using a long short-term memory layer. For example, iterations 620A-620C may be completed by encoder long short-term memory 420 and decoder long short-term memory 425, as disclosed herein with respect to FIG. 4. For example, an encoder, such as encoder long short-term memory 420, may generate a context vector based on the embedded input sequence. The context vector may include word representations that may capture the semantic and syntactic information from the embedded input sequence. Iteration 620A may include as input a start condition and the context vector generated by the encoder. The start condition may indicate to the decoder to begin generating new predictions based on the context vector generated by the encoder. Iteration 620A may output a probability distribution over the vocabulary from the decoder. Iteration 620B may include as input the output of iteration 620A and a hidden state vector through iteration 620A. The hidden state vector may comprise historical information of the sequence through iteration 620A. Iteration 620B may output a probability distribution over the vocabulary from the decoder. Iteration 620C may include as input an end condition and the updated hidden state vector through iteration 620B. The end condition may indicate to the decoder that the end of the input sequence has been reached. The hidden vector may represent the historical outputs of the decoder through each iteration over the context vector. Iteration 620C may output a generated sequence. The generated sequence may comprise a compressed and condensed sequence that corresponds to the input sequence 605. Although FIG. 6 depicts three iterations 620A-620C, machine learning models 315A-315C may complete more or fewer iterations depending on the length of the input sequence 605. The generated sequence may then be transmitted to postprocessing 625. Postprocessing 625 may convert the generated sequence into a format that may be interpreted by a large language model.

FIG. 7 is a flowchart of a process 700 for updating an input for at least one large language model. Although FIG. 7 shows example blocks of process 700, in some implementations, process 700 may include additional blocks, fewer blocks, different blocks, or differently arranged blocks than those depicted in FIG. 7. Additionally, or alternatively, two or more of the blocks of process 700 may be performed in parallel.

Step 705 of process 700 may include receiving an input from a user. The input received from a user may correspond to input sequence 605, as disclosed herein with respect to FIG. 6. In some embodiments, the input may comprise at least one of a prompt, a recorded session, an audit log, a policy, a code snippet, or a computer file. In some embodiments, process 700 may include converting the input into a text format. The input received from the user may be text, one or more files, one or more images, one or more videos, or any other format capable of being entered into a machine learning model. If the input from the user is not already in a text format, then process 700 may include converting the input into a text format. Process 700 may convert the input into a text format through an image-to-text model which may provide image captioning to generate a textual description of the image or video input or optical character recognition to convert text presented in an image or video input into text.

Step 710 of process 700 may include applying a token classification model to the input to generate a replacement dictionary. The token classification model may correspond to token classification model 305, as disclosed herein with respect to FIG. 3. For example, the token classification model may comprise a natural language model configured to assign a label to specific tokens in the input received from the user at step 705 of process 700. In some embodiments, the token classification model may utilize a Name Entity Recognition to identify specific entities in an input, such as a date, an individual, a place, a task, an organization, or any other specific entity in an input. The token classification model may label each identified entity to generate a replacement dictionary. The replacement dictionary may include each of the identified entities and a replacement label for each identified entity. For example, in some embodiments, the replacement dictionary may comprise one or more classified entities associated with the input. The replacement label for each identified entity may be applied to the input to reduce the size of the input.

Step 715 of process 700 may include applying a classification algorithm to the input to classify at least one of a nature or a structure of the input. The classification algorithm may correspond to classification algorithm 310, as disclosed herein with respect to FIG. 3. For example, the classification algorithm may comprise a machine learning process of categorizing an input into classes based on one or more variables. The classification algorithm may classify at least one of a nature or a structure of the received input. The nature of the received input may include a task type of the input. For example, the input may comprise a task to summarize the input, explain the input, analyze the input, or any other task related to the input. The structure of the input may comprise a format of the input. For example, the input may comprise a recorded session, an audit log, a policy, a code snippet, a computer file, or any other format of input. The classification algorithm may identify and classify the nature or the structure of the input.

In some embodiments, process 700 may include identifying from a plurality of trained machine learning models the trained machine learning model for updating the input based on the classified nature or structure of the input. For example, the system executing process 700 may comprise a plurality of trained machine learning models, such as machine learnings models 315A-315C, as disclosed herein with respect to FIG. 3. The plurality of machine learning models may each be configured to convert the input for the at least one large language model in view of a summarization related task, a code analysis related task, a log analysis related task, an audit analysis related task, or a configuration related task. A summarization related task may provide a shorter version of an input while preserving the contextually important information. A code analysis related task may provide analysis of code or minification of code. A log analysis related task may analyze a log file or a recorded session. An audit analysis related task may analyze an audit log or a recorded session audit. A configuration related task may merge or adjust policies or configurations. Each of machine learning models 315A-315C may be suited to convert the input to a specific format, based on the identified nature or structure of the input. For example, a machine learning model may be suited to convert the input to emojis, to binary, or to any other input format. The classification of the nature or structure of the input by classification algorithm 310 may determine which of machine learning models 315A-315C may convert the input. Each of the plurality of machine learning models may be suited to analyze and update an input. Therefore, process 700 may identify a machine learning model suitable for updating the input based on the classified nature or structure of the input.

In some embodiments, process 700 may include identifying, based on the classified nature or structure of the input, at least one large language model, converting the input by a trained machine learning model, and transmitting the converted input and the replacement dictionary to the identified at least one large language model. For example, the system executing process 700 may comprise a plurality of large language models, such as large language models 320A-320C, as disclosed herein with respect to FIG. 3. In such an embodiment, each trained machine learning model may correspond to at least one large language model. The large language model that may be most suitable to generate answer data in response to an updated input may be identified based on the identified trained machine learning model. The updated input may be transmitted to the large language model that is identified based on the identified trained machine learning model.

In some embodiments, the classification algorithm may identify a structure or a nature of the input and a corresponding large language model. For example, the system executing process 700 may comprise a plurality of large language models, such as large language models 320A-320C, as disclosed herein with respect to FIG. 3. Each of the at least one large language models may be suitable for receiving and analyzing specific categories of inputs. For example, each large language model may be suited to receive and analyze a prompt, a recorded session, an audit log, a policy, a code snippet, or a computer file. Further, each large language model may be suited to complete a specific task type, such as to summarize, analyze, or configure the updated input. The classification algorithm may identify a large language model that may be the most suitable large language model to provide answer data in response to the updated input based on the structure or nature of the input.

Step 720 of process 700 may include updating the input based on the replacement dictionary. The replacement dictionary generated by the token classification model in step 710 of process 700 may contain a plurality of labels that may be associated with specific entities in an input, such as a date, an individual, a place, a task, an organization, or any other specific entity in an input. Step 720 of process 700 may include replacing the entities identified by token classification model with the corresponding replacement labels contained in the replacement dictionary. The replacement label for each identified entity may be, for example, shorter in length than the identified entity name, which may reduce the input size of the overall updated input to the machine learning model.

Step 725 of process 700 may include identifying, based on the classified nature or the structure of the input, at least one large language model. Each of the at least one large language models may be suitable for receiving and analyzing specific categories of inputs. For example, one large language model may be suited to receive and analyze a prompt, a recorded session, an audit log, a policy, a code snippet, or a computer file. Further, each large language model may be suited to complete a specific task type, such as to summarize, analyze, or configure the updated input. At least one large language model may be identified based on the classified nature or structure of the input. The at least one identified large language model may be identified as the most suitable large language model to provide answer data in response to the updated input based on the classified nature or structure of the input.

Step 730 of process 700 may include converting the input by a trained machine learning model. In some embodiments, the trained machine learning model may comprise a sequence-to-sequence model with an encoder-decoder neural network architecture using long short-term memory layers. Converting the input by a trained machine learning model may correspond to converting input sequence 605 as disclosed herein with respect to FIG. 6. For example, updating the input by a trained machine learning model may comprise: transmitting the input to a tokenization model, such as tokenization model 610 as disclosed herein with respect to FIG. 6 or tokenization model 410 as disclosed herein with respect to FIG. 4. Tokenization of the input may convert the input into a format that may be more easily interpreted and analyzed by machine learning models, such as machine learning models 315A-315C as disclosed herein with respect to FIG. 3. The tokenization model may comprise sentence tokenization, word tokenization, character tokenization, whitespace tokenization, subword tokenization, or any other form of tokenization suitable for converting the input into tokens. The tokenized input may be transmitted to an embedding model, such as embedding model 615 as disclosed herein with respect to FIG. 6 or embedding model 415 as disclosed herein with respect to FIG. 4. The embedding model may comprise a trained algorithm that may condense the tokenized input into dense representations in a multi-dimensional space. For example, the embedding model may convert the tokenized input into an embedded input sequence.

Machine learning models, such as machine learning models 315A-315C, may iterate over the embedded input sequence through, for example iterations 620A-620C, as disclosed herein with respect to FIG. 6. The machine learning models may complete iterations through an encoder-decoder architecture using a long short-term memory layer. For example, the iterations may be completed by an encoder long short-term memory, such as encoder long short-term memory 420 and a decoder long short-term memory, such as decoder long short-term memory 425, as disclosed herein with respect to FIG. 4. For example, an encoder, such as encoder long short-term memory 420, may generate a context vector based on the embedded input sequence. The context vector may include word representations that may capture the semantic and syntactic information from the embedded input sequence. The first iteration, such as iteration 620A, may include as input a start condition and the context vector generated by the encoder. The start condition may indicate to the decoder to begin generating new predictions based on the context vector generated by the encoder. The first iteration may output a probability distribution over the vocabulary from the decoder. A second iteration, such as iteration 620B, may include as input the output of the first iteration and a hidden state vector through the first iteration. The hidden state vector may comprise historical information of the sequence through the first iteration. The second iteration may output a probability distribution over the vocabulary from the decoder. A third iteration, such as iteration 620C, may include as input an end condition and the updated hidden state vector through the second iteration. The end condition may indicate to the decoder that the end of the input sequence has been reached. The hidden vector may represent the historical outputs of the decoder through each iteration over the context vector. The third iteration may output a generated sequence. The generated sequence may comprise a compressed and condensed sequence that corresponds to the input sequence. Although three iterations are described herein, process 700 may complete more or fewer iterations depending on the length of the input sequence.

In some embodiments, process 700 may include converting the updated input into a format readable by the at least on large language model. For example, in some embodiments, the at least one large language model may accept input in a text format, an emoticon format, an image format, a file format, a CSV format, or any other format that may be input into a large language model. Process 700 may include converting the updated input into any type of format that may be most suitable for the at least one large learning model.

Step 735 of process 700 may include transmitting the converted input and the replacement dictionary to the at least one large language model. The at least one large language model may correspond to large language model 320A-320C, as disclosed herein with respect to FIG. 3. For example, in some embodiments, the at least one large language model may comprise a large language model such as Open AI GPT™, Meta LLaMA™, Google Gemini™, Google Bard™, Microsoft Copilot™, Anthropic Claude™, or any other type of model or operation associated with a natural language. The at least one large language model may be in any desired form, such as a statistical model (e.g., a word n-gram language model, an exponential language model, or a skip-gram language model) or a neural model (e.g., a recurrent neural network-based language model or a LLM). The updated input may comprise a compressed input corresponding to the input received by the user at step 705 of process 700. The updated input may be a reduced size that may meet the large language model's input size restrictions. Process 700 may further include transmitting the replacement dictionary generated at step 710 of process 700 and instructions for the large language model to look for compressed input references in the replacement dictionary. Providing the replacement dictionary and instructions to the at least one machine learning model may allow the at least one machine learning model to identify the replaced entities based on the labels stored in the replacement dictionary.

In some embodiments, process 700 may include identifying, based on the classified nature or the structure of the input, a large language model from the at least one large language model, and transmitting the updated input to the identified large language model. Each of the at least one large language models may be suitable for receiving and analyzing specific categories of inputs. For example, one large language model may be suited to receive and analyze a prompt, a recorded session, an audit log, a policy, a code snippet, or a computer file. Further, each large language model may be suited to complete a specific task type, such as to summarize, analyze, or configure the updated input. A large language model from the at least one large language model may be identified during process 700 based on the classified nature or structure of the input. The identified large language model may be identified as the most suitable large language model from the at least one large language models to provide answer data in response to the updated input. In some embodiments, a first portion of the input may be transmitted to a first large language model and a second portion of the input may be transmitted to a second large language model. In such an embodiment, a first large language model and a second large language model may be identified as suitable for generating answer data in response to a first portion and a second portion of the input. The input may be divided into two or more portions and each portion of the input may be transmitted to a different large language model. Each large language model identified as suitable for receiving each portion of the input may generate answer data in response to the portion of the input received.

In some embodiments, process 700 may further include inferring the input by the at least one machine learning model, a process that may correspond to process 600 as disclosed herein with respect to FIG. 6. Inferring by the machine learning model may include, for example, transmitting the input to a tokenization model, such as tokenization model 610, as disclosed herein with respect to FIG. 6. Tokenization model 610 may correspond to tokenization model 410, as disclosed herein with respect to FIG. 4. For example, tokenization of input may convert the input into a format that may be more easily interpreted and analyzed by machine learning models. The tokenization model may comprise sentence tokenization, word tokenization, character tokenization, whitespace tokenization, subword tokenization, or any other form of tokenization suitable for converting input 605 into tokens. The tokenized input 605 may be transmitted to a trained embedding model, such as embedding model 615, and receiving an embedded input sequence from the trained embedding model. The machine learning model, such as machine learning models 315A-315C, may iterate over the embedded input sequence, for example through iterations 620A-620C. The machine learning models may complete the iterations through an encoder-decoder architecture using a long short-term memory layer. The first iteration, such as iteration 620A, may include as input a start condition and the context vector generated by the encoder. The start condition may indicate to the decoder to begin generating new predictions based on the context vector generated by the encoder. The first iteration may output a probability distribution over the vocabulary from the decoder. The second iteration, such as iteration 620B, may include as input the output of the first iteration and a hidden state vector through the first iteration. The hidden state vector may comprise historical information of the sequence through the first iteration. The second iteration may output a probability distribution over the vocabulary from the decoder. A third iteration, such as iteration 620C, may include as input an end condition and the updated hidden state vector through the second iteration. The end condition may indicate to the decoder that the end of the input sequence has been reached. The hidden vector may represent the historical outputs of the decoder through each iteration over the context vector. The third iteration may output a generated sequence.

The decoder may then produce a probability distribution over vocabulary to represent the likelihood of each word being the next word in the sequence. The decoder may generate an output sequence word-by-word and may use an embedding layer to represent the output words. The updated input may be generated by sampling a word from the probability distribution of the decoder to generate the updated output. The generated sequence may comprise a compressed and condensed sequence that corresponds to the input sequence 605. Although FIG. 6 depicts three iterations 620A-620C, machine learning models 315A-315C may complete more or fewer iterations depending on the length of the input sequence 605. The generated sequence may then be transmitted to postprocessing 625. Postprocessing 625 may convert the generated sequence into a format that may be interpreted by a large language model.

It is to be understood that the disclosed embodiments are not necessarily limited in their application to the details of construction and the arrangement of the components and/or methods set forth in the following description and/or illustrated in the drawings and/or the examples. The disclosed embodiments are capable of variations, or of being practiced or carried out in various ways.

The disclosed embodiments may be implemented in a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods, and computer program products according to various embodiments of the present invention. In this regard, each block in the flowcharts or block diagrams may represent a software program, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant virtualization platforms, virtualization platform environments, trusted cloud platform resources, cloud-based assets, protocols, communication networks, security tokens and authentication credentials, and code types will be developed, and the scope of these terms is intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub combination or as suitable in any other described embodiment of the invention. Certain features described in the context of various embodiments are not to be considered essential features of those embodiments unless the embodiment is inoperative without those elements.

Although the invention has been described in conjunction with specific embodiments thereof, it is evident that many alternatives, modifications, and variations will be apparent to those skilled in the art. Accordingly, it is intended to embrace all such alternatives, modifications and variations that fall within the spirit and broad scope of the appended claims.

What is claimed is:

1. A non-transitory computer readable medium including instructions that, when executed by at least one processor, cause the at least one processor to perform operations for updating an input for at least one large language model, the operations comprising:
receiving the input from a user;
applying a token classification model to the input to generate a replacement dictionary;
applying a classification model to the input to classify at least one of a nature or a structure of the input;
updating the input based on the replacement dictionary;
identifying, based on the classified nature or the structure of the input, at least one large language model;
converting the input in view of the at least one large language model by a trained machine learning model; and
transmitting the converted input and the replacement dictionary to the at least one large language model.

2. The non-transitory computer readable medium of claim 1, wherein the operations further comprise:
identifying, based on the classified nature or the structure of the input, a large language model from the at least one large language model; and
transmitting the updated input to the identified large language model.

3. The non-transitory computer readable medium of claim 1, wherein the operations further comprise converting the input into a text format.

4. The non-transitory computer readable medium of claim 1, wherein the replacement dictionary comprises one or more classified entities associated with the input.

5. The non-transitory computer readable medium of claim 1, wherein the operations further comprise identifying from a plurality of trained machine learning models the trained machine learning model for updating the input based on the classified nature or the structure of the input.

6. The non-transitory computer readable medium of claim 1, wherein converting the input for the at least one large language model comprises updating the input in view of at least one of a summarization related task, a code analysis related task, a log analysis related task, an audit analysis related task, or a configuration related task.

7. The non-transitory computer readable medium of claim 1, wherein the input comprises at least one of a prompt, a recorded session, an audit log, a policy, a code snippet, or a computer file.

8. The non-transitory computer readable medium of claim 1, wherein the trained machine learning model comprises a sequence-to-sequence model with an encoder-decoder neural network architecture using long short-term memory layers.

9. The non-transitory computer readable medium of claim 1, wherein the classification algorithm identifies a structure or a nature of the input and a corresponding large language model.

10. The non-transitory computer readable medium of claim 1, wherein the nature of the input comprises a task type of the input.

11. A computer-implemented method for updating an input for at least one large language model, the method comprising:
receiving the input from a user;
applying a token classification model to the input to generate a replacement dictionary;
applying a classification model to the input to classify at least one of a nature or a structure of the input;
updating the input based on the replacement dictionary;
identifying, based on the classified nature or the structure of the input, a large language model from the at least one large language model;
converting the input in view of the identified at least one large language model by a trained machine learning model; and
transmitting the updated input and the replacement dictionary to the at least one large language model.

12. The computer-implemented method of claim 11, wherein training the trained machine learning model comprises:
transmitting the input to a tokenization model;
transmitting a tokenized input to a trained embedding model;
receiving an embedded input sequence from the trained embedding model;
transmitting the embedded input sequence to an encoder;
receiving a context vector from the encoder;
transmitting the context vector to a decoder;
receiving a decoder output from the decoder; and
evaluating the updated input.

13. The computer-implemented method of claim 12, wherein evaluating the updated input comprises:
transmitting a target sequence to a tokenization model;
transmitting a tokenized target sequence to a trained embedding model;
receiving an embedded target sequence from the trained embedding model;
determining a similarity between the decoder output and the embedded target sequence;
generating a loss based on the similarity;
generating a length loss between the decoder output and the embedded target sequence;
generating a total loss score based on the loss and the length loss; and
computing a gradient of the total loss score with respect to parameters of the trained machine learning model.

14. The computer-implemented method of claim 13, further comprising backpropagating the total loss score to adjust the machine learning model parameters.

15. The computer-implemented method of claim 11, wherein updating the input by a trained machine learning model comprises:
transmitting the input to a tokenization model;
transmitting the tokenized input to a trained embedding model;
receiving an embedded input sequence from the trained embedding model;
transmitting the embedded input sequence to an encoder;
receiving a context vector from the encoder;
iterating the context vector from the encoder to receive a probability distribution from a decoder; and
sampling a word from the probability distribution to generate the updated input.

16. The computer implemented method of claim 15, further comprising converting the updated input into a format readable by the at least one large language model.

17. The computer-implemented method of claim 11, further comprising identifying from a plurality of trained machine learning models the trained machine learning model for updating the input based on the classified nature or the structure of the input.

18. The computer-implemented method of claim 17, further comprising:
identifying, based on the identified trained machine learning model, a large language model from the at least one large language models; and
transmitting the input to the identified large language model.

19. The computer-implemented method of claim 11, further comprising transmitting a first portion of the input to a first large language model and transmitting a second portion of the input to a second large language model.

20. The computer-implemented method of claim 11, further comprising replacing a value of the input with a variable from the replacement dictionary.
